(19) United States
(12) Patent Application Publication
(10) Pub. No.: US 2008/0146705 A1
(43) Pub. Date: Jun. 19, 2008

(54) Polyamide Compositions, Methods of Manufacture Thereof, and Articles Comprising the Same

(75) Inventors: Ramya Kumaraswamy, Karnataka (IN); Manjunath HR, Karnataka (IN); Sanjay Gurbasappa Charati, Karnataka (IN); Herve Gilbert Cartier, Bellefontaine (FR); Alexis Chopin, Saint Maximin (FR)

Correspondence Address: CANTOR COLBURN, LLP, 20 Church Street, 22nd Floor, Hartford, CT, 06103, US

(73) Assignee: GENERAL ELECTRIC COMPANY, Schenectady, NY (US)

(21) Appl. No.: 11/626,200

(22) Filed: Jan. 23, 2007

Related U.S. Application Data
(60) Provisional application No. 60/870,244, filed on Dec. 15, 2006.

(51) Int. Cl. C08K 5/3492

(52) U.S. Cl. 524/101

(57) ABSTRACT

Disclosed herein is a flame-retardant polyamide composition, comprising about 60 to about 90 weight percent a polyamide composition; and a flame-retardant composition, comprising about 15 to about 30 wt % of a condensed triazine derivative; and about 5 to about 15 wt % of the reaction product of a triazine derivative with a cyanuric acid; and wherein the ratio of the weight of the condensed triazine derivative to the weight of the reaction product of a triazine derivative with a cyanuric acid is greater than 1.

### CROSS-REFERENCE TO RELATED APPLICATION

This application claims the benefit of U.S. Patent Application Ser. No. 60/870,244, filed Dec. 15, 2006, which is incorporated by reference herein in its entirety

### BACKGROUND

This disclosure is related to polyamide compositions, methods of manufacture thereof and articles comprising the same.

Polymeric materials used for electrical applications generally have to meet stringent industry standards for flame-retardancy, while at the same time exhibiting good mechanical properties, such as tensile modulus and tensile strength. It is generally desirable for polymeric materials used for electrical applications to meet or exceed standards designed by the International Electrotechnical Commission (IEC), Glow Wire Ignition temperature (GWIT), or Underwriters Laboratories, Inc. UL-94 flammability class rating.

Polyamides provide outstanding heat resistance and mold workability, making them useful for a variety of applications. However, polyamides display poor flame resistance. In order to render polyamides flame-retardant, it is desirable to add flame-retardant additives. Flame-retardant halogenated compounds, such as brominated flame-retardants are often used to achieve flame retardancy in polyamide compositions. However, brominated flame-retardants raise environmental concerns, which limit their application.

It is therefore desirable to have halogen-free flame-retardant polyamide compositions that exhibit good flame-retardant properties, while at the same time displaying good mechanical properties.

### SUMMARY

Disclosed herein is a flame-retardant polyamide composition, comprising about 60 to about 90 weight percent a polyamide composition; and a flame-retardant composition, comprising about 15 to about 30 wt % of a condensed triazine derivative; and about 5 to about 15 wt % of the reaction product of a triazine derivative with a cyanuric acid; and wherein the ratio of the weight of the condensed triazine derivative to the weight of the reaction product of a triazine derivative with a cyanuric acid is greater than or equal to about 1.

Disclosed herein too is a method comprising melt blending about 60 to about 90 weight percent a polyamide composition; and a flame-retardant composition to form a flame-retardant polyamide composition, wherein the flame-retardant composition comprises about 15 to about 30 wt % of a condensed triazine derivative; and about 5 to about 15 wt % of the reaction product of a triazine derivative with a cyanuric acid; and wherein the ratio of the weight of the condensed triazine derivative to the weight of the reaction product of a triazine derivative with a cyanuric acid is greater than or equal to about 1.

The above described and other features are exemplified by the following detailed description.

### DETAILED DESCRIPTION

The terms “first,” “second,” and the like, “primary,” “secondary,” and the like, as used herein do not denote any order, quantity, or importance, but rather are used to distinguish one element from another. The terms “a” and “an” do not denote a limitation of quantity, but rather denote the presence of at least one of the referenced item. “Optional” or “optionally” means that the subsequently described event or circumstance may or may not occur, and that the description includes instances where the event occurs and instances where it does not. The term “independently selected from”, “independently, at each occurrence” or similar language, means that the labeled substitution groups may appear more than once and may be the same or different when appearing multiple times in the same structure. Thus the R¹ may be the same or different than the R² and if the labeled R² substitution group appears four times in a given permutation of Formula I, then each of those labeled R² substitution groups may be, for example, a different alkyl group falling within the definition of R². All ranges disclosed herein are inclusive of the endpoints, and the endpoints are independently combinable with each other.

Disclosed herein are flame-retardant polyamide compositions that comprise a polyamide composition and a flame-retardant composition. In one embodiment, the flame-retardant composition generally comprises (a) a condensed triazine derivative and (b) a reaction product of a triazine derivative with cyanuric acid. The flame-retardant polyamide compositions advantageously exhibit a flammability class rating according to Underwriters Laboratories Inc. UL-94 of at least V-2, more specifically at least V-1, and yet more specifically at least V-0 at a thickness of up to about 1.6 millimeters (mm).

The flame-retardant polyamide compositions advantageously exhibit a flammability class rating according to Underwriters Laboratories Inc. UL-94 of at least V-2, more specifically at least V-1, and yet more specifically at least V-0 at a thickness of up to about 1.6 millimeters (mm). The flame-retardant polyamide compositions advantageously exhibit a flammability class rating according to Underwriters Laboratories Inc. UL-94 of at least V-2, more specifically at least V-1, and yet more specifically at least V-0 at a thickness of up to about 0.8 millimeters, specifically at a thickness of up to about 1.2 millimeters, and more specifically at a thickness of up to about 1.6 millimeters.

The polyamide composition comprises polyamides, also known as nylons. Polyamides are characterized by the presence of an amide group (—C(O)NH—). In one embodiment, the polyamides can be synthesized by several methods, including the polymerization of a monoamino monocarboxylic acid or a lactam having at least 2 carbon atoms between the amino group and the carboxylic acid group. In another embodiment, the polyamides can be synthesized by the polymerization of substantially equimolar proportions of a diamine, which contains at least 2 carbon atoms between the amino groups and a dicarboxylic acid. In yet another embodiment, the polyamides can be synthesized by the polymerization of a monoaminocarboxylic acid or a lactam, together with substantially equimolar proportions of a diamine and a dicarboxylic acid. The dicarboxylic acid can be used in the form of a functional derivative thereof, for example, a salt, an ester or an acid chloride. Polyamides are also commercially available from a wide variety of sources.

Nylon-6, for example, is a polymerization product of caprolactam. Nylon-6,6 is a condensation product of adipic acid and 1,6-diaminohexane. Likewise, nylon-4,6 is a condensation product between adipic acid and 1,4-diaminobutane. Besides adipic acid, other useful diacids for the preparation of nylons include azelaic acid, sebacic acid, dodecane diacid, as well as terephthalic and isophthalic acids, and the like. Other useful diamines include diamino m-xylene, di-(4-aminophenyl) methane, di-(4-aminocyclohexyl)methane, 2,2-di-(4-aminophenyl)propane, 2,2-di-(4-aminocyclohexyl)propane, among others.

Exemplary polyamides comprise polypyrrolidone (nylon-4), polycaprolactam (nylon-6), polycapryllactam (nylon-8), polyhexamethylene adipamide (nylon-6,6), polyundecanolactam (nylon-11), polydodecanolactam (nylon-12), polyhexamethylene azelaiamide (nylon-6,9), polyhexamethylene, sebacamide (nylon-6,10), polyhexamethylene isophthalamide (nylon-6,I), polyhexamethylene terephthalamide (nylon-6,T), polyamide of hexamethylene diamine and n-dodecanedioic acid (nylon-6,12), as well as polyamides resulting from terephthalic acid and/or isophthalic acid and trimethyl hexamethylene diamine, polyamides resulting from adipic acid and meta xylenediamines, polyamides resulting from adipic acid, azelaic acid and 2,2-bis-(p-aminocyclohexyl)propane, polyamides resulting from terephthalic acid and 4,4′-diamino-dicyclohexylmethane, or the like, or combinations comprising one at least one of the foregoing polyamides. The polyamide composition may also comprise two or more polyamides. For example the polyamide composition may comprise nylon-6 and nylon-6:6.

Copolymers of the foregoing polyamides are also suitable for use in the practice of the present disclosure. Exemplary polyamide copolymers comprise copolymers of hexamethylene adipamide/caprolactam (nylon-6,6/6), copolymers of caproamide/undecamide (nylon-6/11), copolymers of caproamide/dodecamide (nylon-6/12), copolymers of hexamethylene adipamide/hexamethylene isophthalamide (nylon-6,6/6,I), copolymers of hexamethylene adipamide/hexamethylene terephthalamide (nylon-6,6/6,T), copolymers of hexamethylene adipamide/hexamethylene azelaiamide (nylon-6,6/6,9), or the like, or a combination comprising at least one of the foregoing polyamide copolymers.

Polyamides, as used herein, also comprise the toughened or super tough polyamides. Generally, these super tough nylons are prepared by blending one or more polyamides with one or more polymeric or copolymeric elastomeric toughening agents. Suitable toughening agents can be straight chain or branched as well as graft polymers and copolymers, including core-shell graft copolymers, and are characterized as having incorporated therein either by copolymerization or by grafting on the preformed polymer, a monomer having functional and/or active or highly polar groupings capable of interacting with or adhering to the polyamide matrix so as to enhance the toughness of the polyamide polymer.

In one embodiment, polyamides used in the flame-retardant polyamide composition have an intrinsic viscosity of tip to about 4 deciliters per gram (dl/g) can be used, or, more specifically, having a viscosity of about 0.2 to about 3.5 dl/g, or, even more specifically, having a viscosity of about 1.0 to about 2.4 dl/g, as measured in a 0.5 wt % solution in 96 wt % sulfuric acid in accordance with ISO 307.

In one embodiment, the polyamide comprises a polyamide having an amine end group concentration greater than or equal to 35 microequivalents amine end group per gram of polyamide (μeq/g) as determined by titration with HCl. Within this range, the amine end group concentration may be greater than or equal to 40 μeq/g, or, more specifically, greater than or equal to 45 μeq/g. The maximum amount of amine end groups is determined by the polymerization conditions and molecular weight of the polyamide. Amine end group content can be determined by dissolving the polyamide in a suitable solvent, optionally with heat. The polyamide solution is titrated with 0.01N hydrochloric acid (HCl) solution using a suitable indication method. The amount of amine end groups is calculated based upon the volume of HCl solution added to the sample, the volume of HCl used for the blank, the molarity of the HCl solution and the weight of the polyamide sample.

The polyamide composition comprises polyamide in an amount sufficient to form a continuous phase or co-continuous phase of the flame-retardant polyamide composition. The amount of polyamide can be about 30 to about 98 weight percent, more specifically about 50 to about 95 weight percent, even more specifically about 60 to about 90 weight percent the total weight of the flame-retardant polyamide composition.

As noted above, the flame-retardant polyamide composition further comprises a flame-retardant composition. The flame-retardant composition comprises (a) a condensed triazine derivative and (b) a reaction product of a triazine derivative with cyanuric acid. Condensed triazine derivatives used in the flame-retardant polyamide composition can have a structure corresponding to the formula (I)

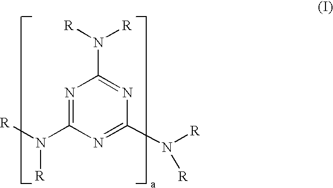

or a structure corresponding to the formula (II)

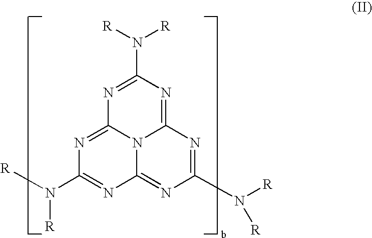

wherein R is independently hydrogen, a C₁-C₈ alkyl, C₃-C₁₆ cycloalkyl, or a C₆-C₁₂ aryl; and a and b are integers between 1 and 500.

In one exemplary embodiment, the condensed triazine derivative is melamine, wherein in the formula (I) above, R is hydrogen, and a=1. In another advantageous embodiment, the condensed triazine derivative is melam, wherein in the formula (I) above, R is hydrogen, and a=2. The structure for melam is shown in the formula (III) below:

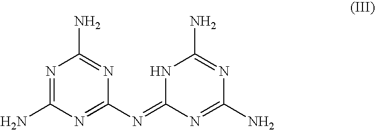

In another exemplary embodiment, the condensed triazine derivative is melem, wherein according to formula (II) above, R is hydrogen and b=1. The structure for melem is shown in the formula (IV) below:

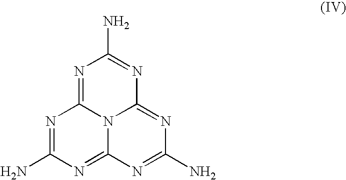

In yet another exemplary embodiment, the condensed triazine derivative is melon, wherein according to formula II, R is hydrogen, and b is greater than or equal to 2. The structure for melon is shown in the formula (V) below:

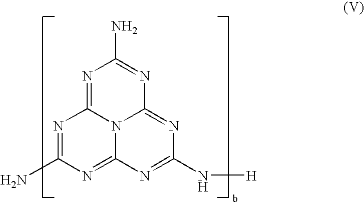

In one embodiment, the condensed triazine derivative can be melon, melam, melem, or a combination comprising at least one of the foregoing condensed triazine derivatives.

In one embodiment, the condensed triazine derivative is present in the flame retardant polyamide composition in an amount of about 15 to about 30 wt %, specifically about 17 to about 28, and more specifically about 18 to about 27 wt %, based upon the weight of the flame retardant polyamide composition.

As noted above, the flame retardant composition also comprises a reaction product of a triazine derivative with cyanuric acid as shown in the formula (VI) or (VII) below:

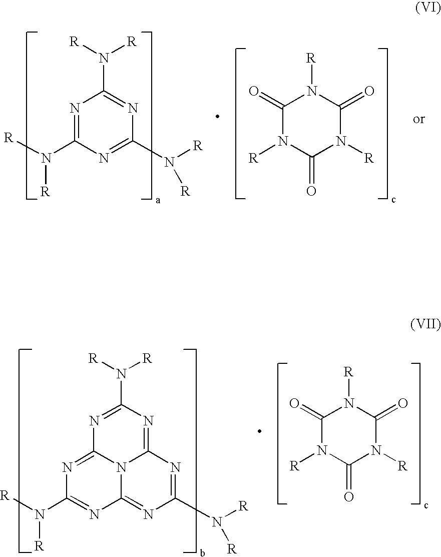

wherein R, a, and b are as defined above, and c is independently an integer between 1 and 500. In one embodiment, the reaction product of a triazine derivative with cyanuric acid can comprise a combination comprising at least one of the foregoing compounds shown in the structures (VI) and (VII).

One exemplary reaction product of a triazine derivative with cyanuric acid is melamine cyanurate wherein in the formula (IV), R is hydrogen and a and c are each equal to 1. The structure for melamine cyanurate is shown in the formula (VIII) below:

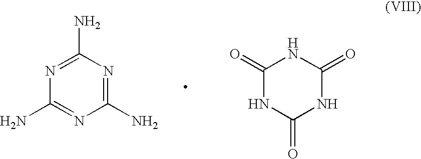

In one embodiment, the reaction product of a triazine derivative with cyanuric acid is present in flame-retardant polyamide composition in an amount of about 5 to about 15, specifically about 6 to about 14, and more specifically about 7 to about 12 weight percent of the total weight of the flame-retardant polyamide composition.

In an exemplary embodiment, it is desirable for the ratio of the weight of condensed triazine derivative to the weight of the reaction product of a triazine derivative with cyanuric acid to be greater than or equal to about 1, specifically greater than or equal to about 1.5, more specifically greater than or equal to about 2, more specifically greater than or equal to about 2.5, and even more specifically greater than or equal to about 3.

Other additives can also be added to all of the flame-retardant polyamide composition at the time of mixing or molding of the resin in amounts that do not have any deleterious effect on physical properties. For example, coloring agents (pigments or dyes), heat-resistant agents, oxidation inhibitors, organic fibrous fillers, weather-proofing agents, lubricants, mold release agents, plasticizers, and fluidity enhancing agents, and the like, and combinations thereof can be added to the flame-retardant polyamide composition.

The preparation of the flame-retardant polyamide composition can be achieved by blending the ingredients under conditions that produce an intimate blend. All of the ingredients can be added initially to the processing system, or else certain additives can be precompounded with one or more of the primary components.

In one embodiment, the flame-retardant polyamide composition is manufactured by blending the polyamide composition with the flame retardant composition. The blending can be dry blending, melt blending, solution blending or a combination comprising at least one of the foregoing forms of blending.

In one embodiment, the polyamide composition and the flame retardant composition can be dry blended to form a mixture in a device such as a Henschel mixer or a Waring blender prior to being fed to an extruder, where the mixture is melt blended. In another embodiment, a portion of the polyamide composition can be premixed with the flame retardant composition to form a dry preblend. The dry preblend is then melt blended with the remainder of the polyamide composition in an extruder. In one embodiment, some of the polyamide composition can be fed initially at the mouth of the extruder while the remaining portion of the polyamide composition is fed through a port downstream of the mouth. Blending of the composition involves the use of shear force, extensional force, compressive force, ultrasonic energy, electromagnetic energy, thermal energy or combinations comprising at least one of the foregoing forces or forms of energy and is conducted in processing equipment wherein the aforementioned forces are exerted by a single screw, multiple screws, intermeshing co-rotating or counter rotating screws, non-intermeshing co-rotating or counter rotating screws, reciprocating screws, screws with pins, barrels with pins, rolls, rams, helical rotors, or combinations comprising at least one of the foregoing.

Blending involving the aforementioned forces may be conducted in machines such as single or multiple screw extruders, Buss kneader, Henschel, helicones, Ross mixer, Banbury, roll mills, molding machines such as injection molding machines, vacuum forming machines, blow molding machine, or then like, or combinations comprising at least one of the foregoing machines.

The flame-retardant composition can be introduced into the melt blending device in the form of a masterbatch. In such a process, the masterbatch may be introduced into the blending device downstream of the point where the polyamide composition is introduced.

In one embodiment, the flame-retardant polyamide composition disclosed herein are used to prepare molded articles such as for example, durable articles, electrical and electronic components, automotive parts, and the like. The compositions can be converted to articles using common thermoplastic processes such as film and sheet extrusion, injection molding, gas-assisted injection molding, extrusion molding, compression molding and blow molding.

In one embodiment, the flame-retardant polyamide compositions when prepared into 1.6 millimeter (mm) test specimens, exhibit a flammability class rating according to Underwriters Laboratories Inc. UL-94 of at least V-2, more specifically at least V-1, and yet more specifically at least V-0.

Furthermore, the compositions described herein have been found to exhibit a Glow Wire Ignition Temperature (GWIT) as measured according to IEC-60695-2-13 of greater than 750° C. at a test specimen thickness of about 1.6 mm, more specifically greater than about 775° C., and yet more specifically greater than about 800° C.

The following examples, which are meant to be exemplary, not limiting, illustrate compositions and methods of manufacturing of some of the various embodiments of the flame-retardant polyamide compositions described herein.

### EXAMPLES

These examples were conducted to demonstrate the flame-retardant performance of the flame-retardant polyamide compositions described herein.

The polyamide (PA6 Regular LV) was purchased from Domo International as DOMAMID®. Melamine cyanurate was purchased from Ciba Specialty Chemicals as MELAPUR MC25. Melem was obtained from Delamin Company as DELACAL®380. Irgaphos was purchased from Ciba Specialty Chemicals.

The composition reported in Table 1 below was compounded in a Werner & Pfleiderer twin-screw extruder, using a screw design having a mid range screw severity, at a melt temperature of 220 to 260° C., and at extrusion rates of 45 to 100 kilograms per hour. The resulting resin mixtures were then molded into bars using an injection molding machines. Melt temperatures in the injection molding machine was 220 to 260° C., and mold temperatures were about 50 to 120° C. The molded bars were then tested according to the tests below.

Flammability tests were performed following the procedure of Underwriters Laboratories Inc., UL-94. The test pieces were of 0.8 mm and 1.6 mm in the vertical position. The compositions were then classified as V-0, V-1, or V-2 accordingly

The tensile modulus and tensile strength were measured by ISO Standard 527/1 using a test piece having a width thickness of 4.0 mm. Tensile modulus is reported in gigapascals (GPa) and tensile strength is reported in megapascals (MPa).

The unnotched Izod was measured according to ISO 180-1A and the results are provided in units of Kilo Joules per squared meter (KJ/m²).

The Glow Wire Ignition Temperature (GWIT) was measured and dimensions of 60.0×60.0 mm. GWIT is reported in ° C.

### Examples 1-9

The following examples illustrate the improved flammability, ignition, and mechanical properties of the disclosed compositions over compositions comprising similar components but used in different weight ratios. This example demonstrates the flame retardancy characteristics of flame-retardant polyamide compositions that comprise (a) 5 to 30 weight percent of a condensed triazine derivative having the structure of formulae (IV) and (b) 5 to 15 weight percent of a compound based on reaction products of a triazine derivative with cyanuric acid having the structure of formula (VIII); wherein all percents by weight are based on the total weight of the flame-retardant polyamide composition. As noted above, the condensed triazine derivative is a melem, while the melamine cyanurate is the reaction product of the triazine derivative with cyanuric acid.

Table 1 illustrates the use of different combinations of melem and melamine cyanurate in the flame-retardant polyamide compositions. All amounts are in weight percent (wt %), based on the total weight of the composition. Sample #'s 1-4 are comparative examples that contain a weight ratio of melem to melamine cyanurate that is less than 1, while Sample #'s 5-9 are examples that are representative of the invention, i.e., they contain a weight ratio of melem to melamine cyanurate that is greater than or equal to about 1.

TABLE 1

| | Comp. | Comp. | Comp. | Comp. | | | | | |
|---|---|---|---|---|---|---|---|---|---|
| | Sample | Sample | Sample | Sample | Sample | Sample | Sample | Sample | Sample |
| Composition | #1 | #2 | #3 | #4 | #5 | #6 | #7 | #8 | #9 |
| PA6 Regular LV | 86.25 | 81.25 | 74.25 | 78.05 | 69.25 | 79.25 | 74.25 | 69.25 | 64.25 |
| (wt %) | | | | | | | | | |
| Melem (wt %) | | 5 | 10 | 10 | 15 | 15 | 20 | 20 | 26.25 |
| Melamine | 13 | 13 | 15 | 10 | 15 | 5 | 5 | 10 | 8.75 |
| Cyanurate (wt %) | | | | | | | | | |
| Aluminum | 0.45 | 0.45 | 0.45 | 0.45 | 0.45 | 0.45 | 0.45 | 0.45 | 0.45 |
| Stearate (wt %) | | | | | | | | | |
| Irganox 1068 | 0.15 | 0.15 | 0.15 | 0.15 | 0.15 | 0.15 | 0.15 | 0.15 | 0.15 |
| AO1 (wt %) | | | | | | | | | |
| Irgaphos 168 | 0.15 | 0.15 | 0.15 | 0.15 | 0.15 | 0.15 | 0.15 | 0.15 | 0.15 |
| (wt %) | | | | | | | | | |
| Ratio of | | 0.4 | 0.7 | 1.0 | 1 | 3.0 | 4.0 | 2.0 | 3.0 |
| Melem/Melamine | | | | | | | | | |
| Cyanurate | | | | | | | | | |
| Tensile Modulus | 3.25 | 4.58 | 7.15 | 3.9 | 4.87 | 4 | 3.9 | 4.09 | 4.7 |
| [GPa] | | | | | | | | | |
| Tensile strength | 67.03 | 74.1 | 50.4 | 72.5 | 68 | 56.6 | 72.2 | 69.13 | 65.1 |
| [MPa] | | | | | | | | | |
| GWIT at 1.6 mm | 750 | 800 | 800 | 750 | 775 | 825 | 825 | 825 | 800 |
| [° C.] | | | | | | | | | |
| Elongation at | 18.6 | 4.1 | 1.7 | 3.34 | 2.87 | 3 | 3.83 | 2.93 | 2.68 |
| break [%] | | | | | | | | | |
| Flame | V-0 | V-2 | V-2 | V-2 | V-0 | V-0 | V-0 | V-0 | V-0 |
| performance at | | | | | | | | | |
| 1.6 mm | | | | | | | | | |
| Unnotched | 44.3 | 32.15 | 18 | 27.45 | 17.05 | 20.4 | 21.13 | 18.65 | 16.9 |
| Impact [KJ/m²] | | | | | | | | | |

From Table 1 it may be seen that compositions comprising melem and melamine cyanurate in a weight ratio of melem to melamine cyanurate greater than 1 generally display a superior combination of tensile and flame retardancy properties. For example, Sample #'s 5-9 display a flame performance of V-0, a GWIT of greater than or equal to about 800° C. along with a tensile strength of greater than or equal to about 50 megaPascals (MPa). The comparative examples (Sample #'s 1-4) on the other hand do not display the same combination of superior properties as the examples of the invention.

While the invention has been described with reference to some embodiments, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiments disclosed as the best mode contemplated for carrying out this invention, but that the invention will include all embodiments falling within the scope of the appended claims.

What is claimed is:

1. A flame-retardant polyamide composition, comprising:
about 60 to about 90 weight percent a polyamide composition; and
a flame-retardant composition, comprising:
about 15 to about 30 wt % of a condensed triazine derivative; and
about 5 to about 15 wt % of the reaction product of a triazine derivative with a cyanuric acid; and wherein the ratio of the weight of the condensed triazine derivative to the weight of the reaction product of a triazine derivative with a cyanuric acid is greater than or equal to about 1.

2. The flame-retardant polyamide composition of claim 1, wherein the polyamide composition comprises a polyamide.

3. The flame-retardant polyamide composition of claim 1, wherein the condensed triazine derivative has a structure corresponding to the formula (I) 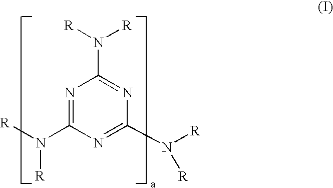
or a structure corresponding to the formula (II) 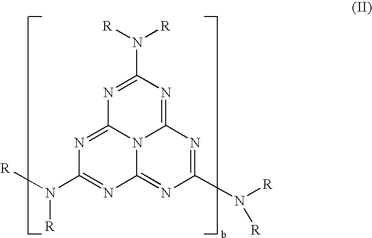
wherein R is independently hydrogen, a C₁-C₈ alkyl, C₃-C₁₆ cycloalkyl, or a C₆-C₁₂ aryl; and wherein a and b are integers between 1 and 500.

4. The flame-retardant polyamide composition of claim 1, wherein the condensed triazine derivative is melam having the structure of figure (III) below: 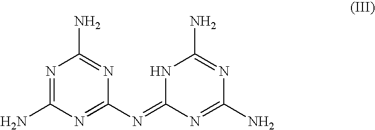
or melem having the structure of figure (IV) below: 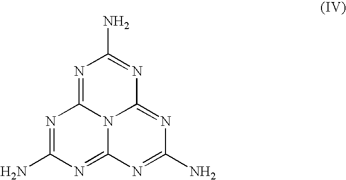
or melon having the structure of figure (V) below: 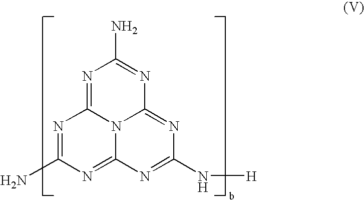
or a combination comprising at least one of the foregoing condensed triazine derivatives.

5. The flame-retardant polyamide composition of claim 1, wherein the reaction product of a triazine derivative with cyanuric acid has a structure shown in the formula (VI) or (VII) below: 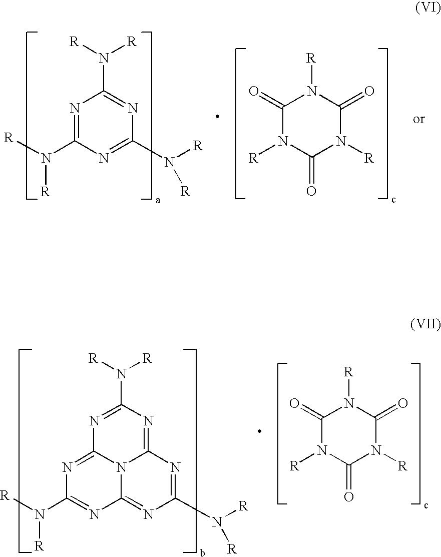
or a combination comprising at least one of the foregoing structures (VI) or (VII); wherein R is independently hydrogen, a C₁-C₈ alkyl, C₃-C₁₆ cycloalkyl, or a C₆-C₁₂ aryl; and wherein a, b and c are all independently integers between 1 and 500.

6. The flame-retardant polyamide composition of claim 1, wherein the reaction product of a triazine derivative with a cyanuric acid is melamine cyanurate having the structure of formula (VIII) below:

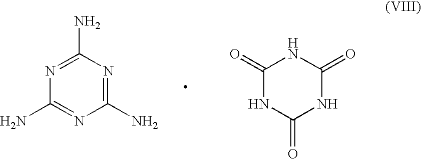

7. The flame-retardant polyamide composition of claim 1, wherein the flame-retardant polyamide composition has a flammability class of V-2 or better when tested according to a Underwriters Laboratories Inc. UL-94 test; and wherein a flame-retardant polyamide composition sample subjected to the Underwriters Laboratories Inc. UL-94 test has a thickness of up to about 1.6 millimeters.

8. The flame-retardant polyamide composition of claim 1, wherein the flame-retardant polyamide composition has a glow wire ignition temperature (GWIT) greater than or equal to 775° C. according to the International Electrotechnical Commission standard IEC-60695-2-13.

9. The flame-retardant polyamide composition of claim 1, wherein the flame-retardant polyamide composition has a glow wire ignition temperature (GWIT) greater than or equal to 775° C. according to the International Electrotechnical Commission standard IEC-60695-2-13, a tensile strength of greater than or equal to about 50 megaPascals and displays flammability class of V-2, or better, when tested according to a Underwriters Laboratories Inc. UL-94 test, and wherein a flame-retardant polyamide composition sample subjected to the Underwriters Laboratories Inc. UL-94 test has a thickness of up to about 1.6 millimeters.

10. An article comprising the flame-retardant polyamide composition of claim 1.

11. A method comprising:
melt blending about 60 to about 90 weight percent a polyamide composition and a flame-retardant composition to form a flame-retardant polyamide composition, wherein the flame-retardant composition comprises:
about 15 to about 30 wt % of a condensed triazine derivative; and
about 5 to about 15 wt % of the reaction product of a triazine derivative with a cyanuric acid; and wherein the ratio of the weight of the condensed triazine derivative to the weight of the reaction product of a triazine derivative with a cyanuric acid is greater than 1.

12. The method of claim 11, wherein the melt blending is conducted in an extruder.

13. The method of claim 11, further comprising injection molding the flame-retardant polyamide composition.

14. An article manufactured by the method of claim 11.
